(19) United States
(12) Patent Application Publication
(10) Pub. No.: US 2002/0122279 A1
(43) Pub. Date: Sep. 5, 2002

(54) Circuit breaker operating handle

(76) Inventors: Randall Lee Greenberg, Granby, CT (US); Girish Hassan, Seconderabad (IN); Roger Neil Castonguay, Terryville, CT (US); James Lawrence Rosen, West Hartford, CT (US); Samuel Stephen Kim, Rocky Hill, CT (US); David Arnold, Chester, CT (US)

Correspondence Address: Carl B. Horton, GENERAL ELECTRIC COMPANY, 41 Woodford Avenue, Plainville, CT, 06062, US

(21) Appl. No.: 09/752,889

(22) Filed: Dec. 29, 2000

(51) Int. Cl. H02H 3/00

(52) U.S. Cl. 361/42

(57) ABSTRACT

An operating handle assembly is provided having an improved handle engagement arrangement, thereby enabling the operating handle assembly to be adaptable for both human and machine interaction without the requirement of special attachment hardware. An operating handle assembly having a handle base and handle stem can accept a first handle extension suitable for human interaction or a second handle extension suitable for machine interaction. Assembly features provide for proper assembly of the handle extension to the handle stem while maintaining appropriate electrical clearances to live parts. The two part operating handle assembly, handle base with handle stem plus handle extension, provides for improved manufacturability of the host device, whereby the end-use construction of the host device need not be identified until a late point in the production cycle. The host device may be, but is not limited to, a standard circuit breaker, a rotary circuit breaker, a switch, or a disconnect device.

### BACKGROUND OF THE INVENTION

The present invention relates generally to an operating handle having a handle extension for use in a circuit breaker, such as a molded case circuit breaker, which has the function of connecting and disconnecting electrical power to and from a protected circuit that typically receives power through an electrical distribution panel. Handle extensions are well known in the art of circuit breakers. An example of a handle extension suitable for circuit breaker application is described in U.S. Pat. No. 5,075,659 entitled “Compact Molded Case Circuit Breaker Having External Contact Condition Indication” ('659 patent), and U.S. Pat. No. 5,084,689 entitled “Compact Molded Case Circuit Breaker With Increased Ampere Rating” ('689 patent).

Operating handles with handle extensions that assist in the operation of a circuit breaker and provide indication of the handle position of a circuit breaker are not only employed in conventional single-contact-pair circuit breakers, but also in other devices, such as two-contact-pair rotary circuit breakers, switches, and disconnects. The applications that these devices are used in are vast, and include, but are not limited to, the utility, industrial, commercial, residential, and automotive industries. The primary function of an operating handle is to provide a means for mechanically interfacing with an operating mechanism to close and open electrical contacts, thereby connecting and disconnecting a protected circuit, respectively. An additional function of an operating handle is to provide a means for indicating the position of the electrical contacts, such as whether they are open or closed.

The operating handle and handle extension must be suitable for both manual and automatic operation. If the circuit breaker, or other such device, is to be operated manually, the operating handle and handle extension must be suitable for human interaction. Alternatively, if the circuit breaker, or other such device, is to be operated automatically, the operating handle and handle extension must be suitable for machine interaction. Typically, an arrangement that is suitable for one type of interaction is not suitable for the other. For example, the aforementioned '659 and '689 patents describe a handle extension that is pivotally attached to an operating handle, whereby the handle extension provides a means for extending the length of the operating handle for improved manual operation of the circuit breaker. While removal of the handle extension would provide a shorter handle that could be used for automatically operating the circuit breaker, the presence of the resulting notch in the operating handle would result in a handle with reduced surface engagement for the interacting machine and undesirable wear to the interacting surfaces. Also, the pivotally attached handle extension requires special attaching hardware that has an appropriate fit for both safe operation and pivotal action. Thus, it would be beneficial to have an operating handle and handle extension that is suitable for both human and machine interaction and does not require special attachment hardware.

### SUMMARY OF THE INVENTION

In an exemplary embodiment of the present invention, an operating handle is provided having an improved handle engagement arrangement, thereby enabling the operating handle to be adaptable for both human and machine interaction without the requirement of special attachment hardware. An operating handle having a base stem can accept a first handle extension suitable for human interaction or a second handle extension suitable for machine interaction. Assembly features provide for proper assembly of the handle extension to the handle stem while maintaining appropriate electrical clearances to live parts. The two part operating handle, handle base with stem plus handle extension, provides for improved manufacturability of the host device, whereby the end-use construction of the host device need not be identified until a late point in the production cycle (i.e., late point identification). Such a host device may be, but is not limited to, a standard circuit breaker, a rotary circuit breaker, a molded case circuit breaker, a switch, or a disconnect device. Host devices such as circuit breakers are frequently employed in electrical distribution panels, which would also benefit from the advantages of the present invention.

The operating handle assembly, including a handle base, base stem, and handle extension, can be made out of any material suitable for the application, including metal or plastic. While plastic may be more suitable for electrical applications because of the additional electrical isolation protection the plastic material provides, metal may also be suitable for electrical applications where the electrical isolation protection is provided by some other means. Suitable metals would include, but are not limited to, steel, stainless steel, brass, aluminum diecast, or zinc diecast. Thermoset-type plastics such as but not limited to polyester, polyester-glass, phenolic, phenolic-glass, epoxy, epoxy-glass, melamine, or melamine-glass, are well suited for operating handle applications because of their strength and electrical properties. Also suitable for operating handle applications are thermoplastic-type plastics such as but not limited to polyethylene, polypropylene, polystyrene, polyester, polyvinyl chloride, acrylics, nylons, spandex-type polyurethanes, polyamides, polycarbonates, fluorocarbons, and cellulosics, because of their flexural and electrical properties. An operating handle assembly manufactured from a thermoplastic-type plastic may be fabricated with snap-fit features to hold the assembly together, while an operating handle assembly manufactured from a thermoset-type plastic will typically require alternate fastening means, such as but not limited to a screw, bolt, pin or clip.

The engagement of the handle extension to the handle stem must be sufficient to transmit the operational forces, exerted by either human or machine, from the handle extension to the handle stem without disengagement of the handle extension from the handle stem. Additionally, the engagement arrangement between handle extension and handle stem must be capable of transmitting the applied handle forces to the operating mechanism without over-stressing the engagement arrangement. The engagement arrangement between handle extension and handle stem can be achieved by a simple box-like arrangement with no ribs or slots. However, for improved transmission of forces between the handle extension and handle stem, ribs and slots are incorporated into the engagement arrangement, thereby providing auxiliary interacting surfaces. While there are many different shapes of ribs and slots that can be employed in an engagement arrangement, shapes that produce interacting surfaces that tend not to force apart the engagement arrangement are preferable.

### BRIEF DESCRIPTION OF THE DRAWINGS

FIG. 1 illustrates a perspective view of an electrical distribution panel incorporating the present invention;

FIG. 2 illustrates an exploded perspective view of an electrical circuit breaker incorporating the present invention;

FIG. 3 illustrates a cutaway side view of an electrical circuit breaker showing internal electrical components;

FIG. 4 illustrates a partial perspective view of an arc chamber of an electrical circuit breaker;

FIG. 5 illustrates a perspective view of an operating handle base incorporating the present invention;

FIG. 6 illustrates a perspective view of a handle extension incorporating the present invention;

FIG. 7 illustrates a perspective view of another handle extension incorporating the present invention;

FIG. 8 is a view similar to FIG. 5 but of an alternative embodiment of this invention;

FIG. 9 is a view similar to FIG. 6 but of an alternative embodiment of this invention;

FIG. 10 is a view similar to FIG. 7 but of an alternative embodiment of this invention; and

FIG. 11 illustrates an operating handle assembly with the handle extension in section view incorporating the present invention.

### DESCRIPTION OF THE PREFERRED EMBODIMENT

Distribution Panel Generally

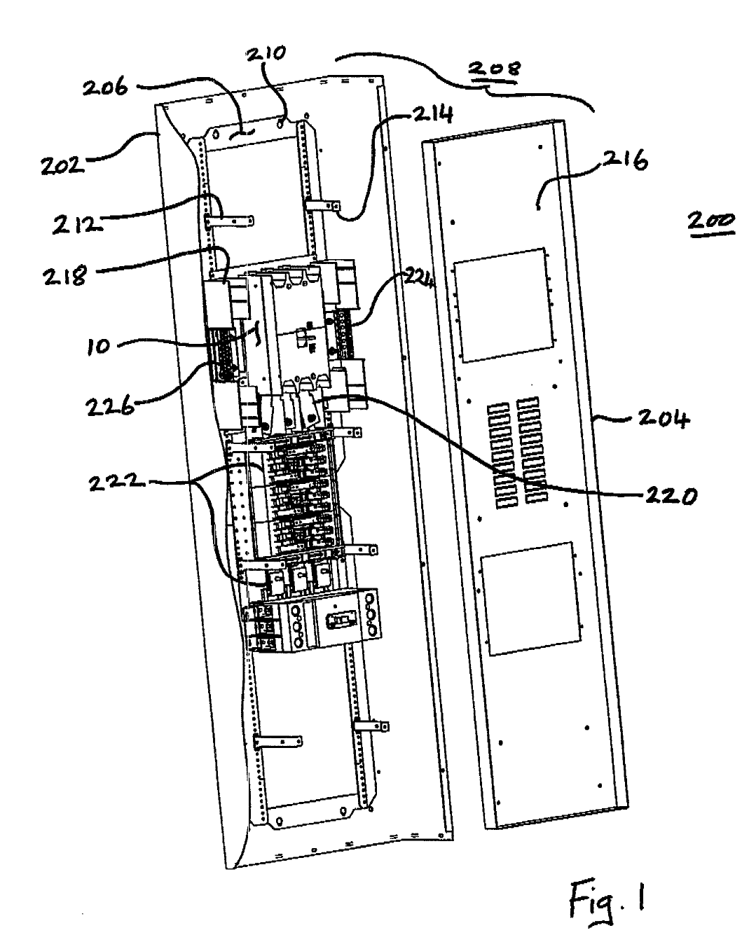

An electrical distribution panel, well known to one skilled in the art of electrical distribution, is depicted generally in FIG. 1, is fully described in commonly assigned U.S. patent application Ser. No. 09/560,226 entitled “Electrical Distribution Panel With Split Neutral Bus” filed Apr. 28, 2000, functions generally to distribute protected power from a common main source to a plurality of branch circuits, and is described generally below.

Referring to FIG. 1, an electrical distribution panel 200 includes a panel base 202, a panel cover 204 and an interior assembly 206. The panel base 202 and panel cover 204 generally make up the panel housing 208 of distribution panel 200. The interior assembly 206 is attached to panel base 202 by suitable fasteners, not shown, through mounting holes 210. Upstanding supports 212 are integral to interior assembly 206 and provide attachment surfaces 214 for attachment of panel cover 204, which is secured to the attachment surfaces 214 by suitable fasteners, not shown, through holes 216 in panel cover 204.

Interior assembly 206 includes main support 218 for mechanically supporting a main circuit device, such as but not limited to a circuit breaker 10 that is fully described below, at least one busbar 220 for connecting circuit breaker 10 to a plurality of branch circuit connections 222, a ground connector 224 for providing an electrical ground connection within the distribution panel 200, and a neutral connector 226 for providing an electrical neutral connection within the distribution panel 200. Power distribution to a plurality of branch circuits, not shown, is made through the plurality of branch circuit connections 222.

Circuit Breaker Generally

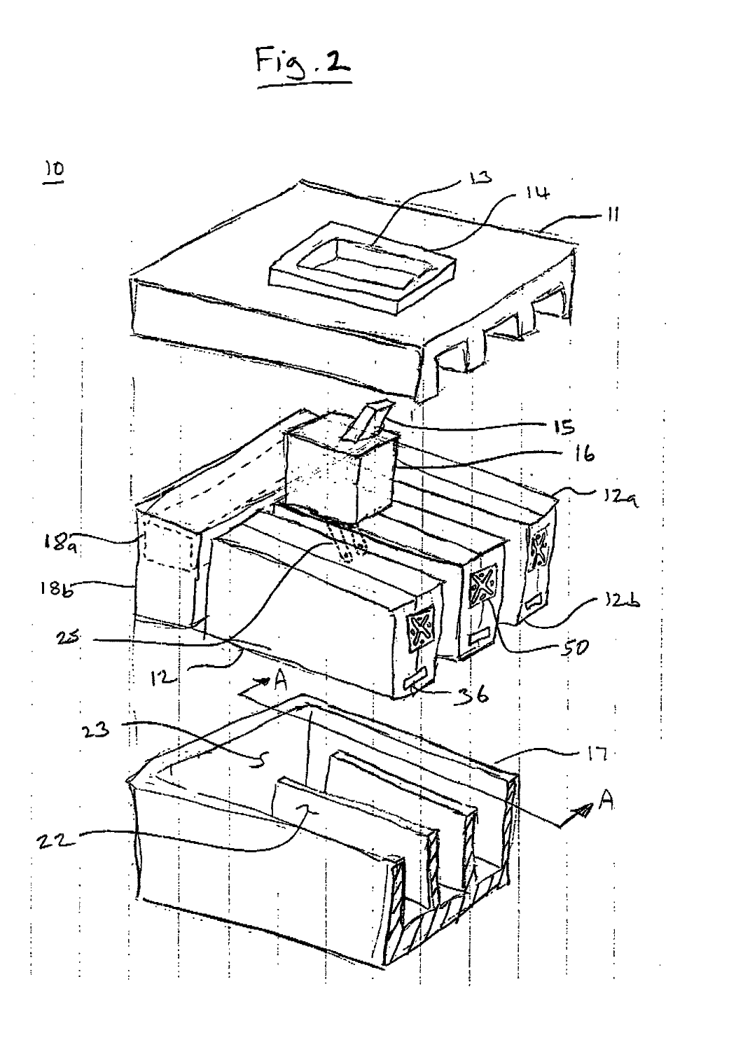

A circuit breaker 10 incorporating the present invention is depicted in the exploded perspective view of FIG. 2. Cassette 12, conventional trip unit 18a in trip unit housing 18b and conventional operating mechanism 16, are captivated between cover 11 and case 17 by fasteners, not shown. Cassette halves 12a,b are secured by fasteners, not shown, and positionally located in pocket 22 of case 17. For simplicity and clarity, where more than one element of the same type is present, only one will be referenced, but the reader will readily recognize that the single reference pertains to more than one element of the same type. Here, for example, there are three cassettes 12 and three pockets 22 where each cassette 12 is positionally located in an associated pocket 22. Reference is made to a cassette 12 and a pocket 22 but the reader will readily recognize that three cassettes 12 and three pockets 22 are present. Also for simplicity and clarity, reference will only be made to a three phase circuit breaker, but the reader will recognize that the present invention is equally applicable to single phase, two phase or multi-phase electrical switching devices of any kind.

Trip unit housing 18b is positionally located in pocket 23 of case 17. Extending through opening 13 of escutcheon 14 on cover 11 is operating handle assembly 15, which is operatively connected between operating mechanism 16 and movable contact arm 20 for opening and closing electrical contacts 21a,b,c,d, best seen by referring to FIG. 2.

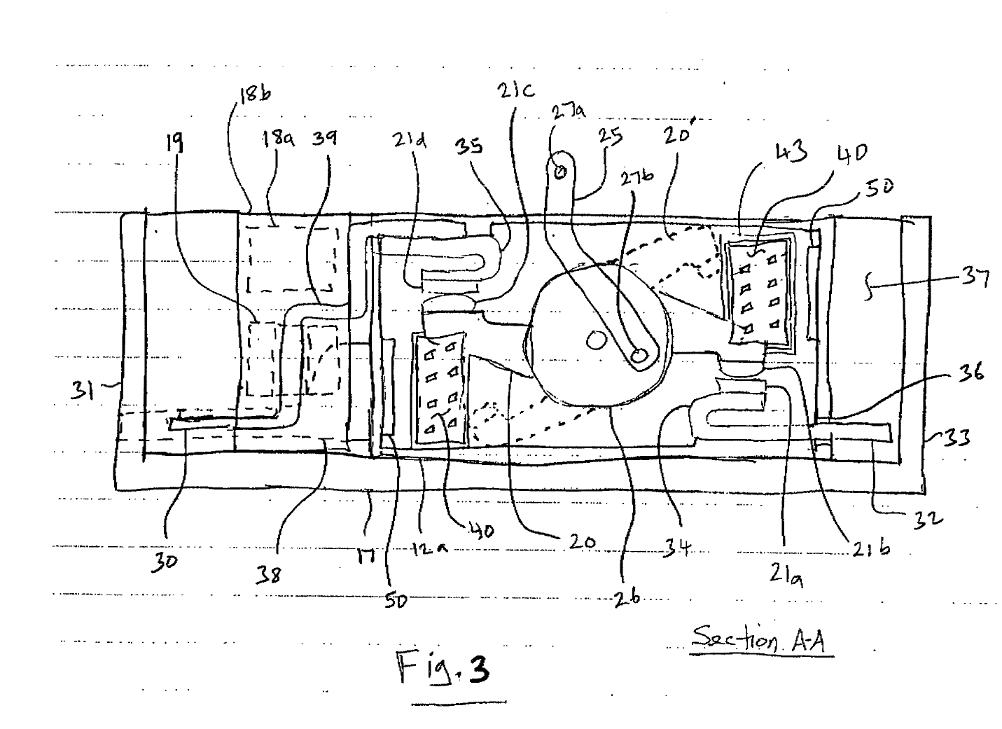

A conventional operating mechanism 16, well known to one skilled in the art and depicted generally in FIG. 1, is fully described in commonly assigned U.S. patent application Ser. No. 09/196,706 entitled “Circuit Breaker Mechanism for a Rotary Contact System” filed Nov. 20, 1998, which is herein fully incorporated by reference. A conventional trip unit 18a, depicted generally in FIG. 2 and in phantom in FIG. 3, is operatively connected between conventional current sensors 19, depicted in phantom in FIG. 3, and operating mechanism 16 to effectuate the opening of contacts 21a,b,c,d upon the occurrence of an abnormal overcurrent condition. A conventional trip unit 18a and conventional current sensors 19 are well known to one skilled in the art and are fully described in commonly assigned U.S. Pat. Nos. 4,589,052, 4,728,914, and 4,833,563, which are herein fully incorporated by reference.

Referring to FIG. 3, which depicts a cutaway side view of cassette 12 and trip unit housing 18b in case 17, electrical connections between the protected circuit, not shown, and circuit breaker 10 are made through load terminal 30 on load side 31 of circuit breaker 10. Electrical connections between the power source, not shown, and circuit breaker 10 are made through line terminal 32 on line side 33 of circuit breaker 10.

Referring to both FIGS. 2 and 3, circuit breaker 10 constructed in accordance with the present invention, includes operating handle assembly 15 for driving operating mechanism 16 to manually open and close electrical contacts 21a,b,c,d. Contact 21a is carried by elongated fixed contact arm 34, contacts 21b,c are carried by elongated movable contact arm 20, and contact 21d is carried by elongated fixed contact arm 35. FIG. 3 also shows movable contact arm 20′, depicted in phantom, following an opening action by trip unit 18a and operating mechanism 16. Fixed contact arm 34 extends through opening 36 of cassette 12 to terminate in line terminal 32, which is accessible through an opening, not shown, in line side 33 of case 17. Obviously, each phase of the multi-phase circuit breaker would have separate conductors per phase, not shown. Operating mechanism 16 is operatively connected to contact arm 20 by link 25, rotor 26, and connecting pins 27a,b.

The current path through circuit breaker 10 in the closed position is best seen by referring to FIG. 3. Under quiescent operating conditions, the current from the power source enters circuit breaker 10 through line terminal 32 (and other line terminals on adjacent phases not shown), and exits through load terminal 30 (and other load terminals on adjacent phases not shown). Between line terminal 32, and load terminal 30, the current path consists of; fixed contact arm 34, electrical contacts 21a and b, movable contact arm 20, electrical contacts 21c and d, fixed contact arm 35, and sensor strap 39. Sensor strap 39 passes through and provides primary current signal to current sensor 19, which is operatively connected to trip unit 18a. Fixed contact arm 35 is mechanically and electrically connected to sensor strap 39 by a fastener, not shown. Sensor strap 39 passes through openings, not shown, in trip unit housing 18b to terminate in load terminal 30, which is accessible through an opening, not shown, in load side 31 of case 17.

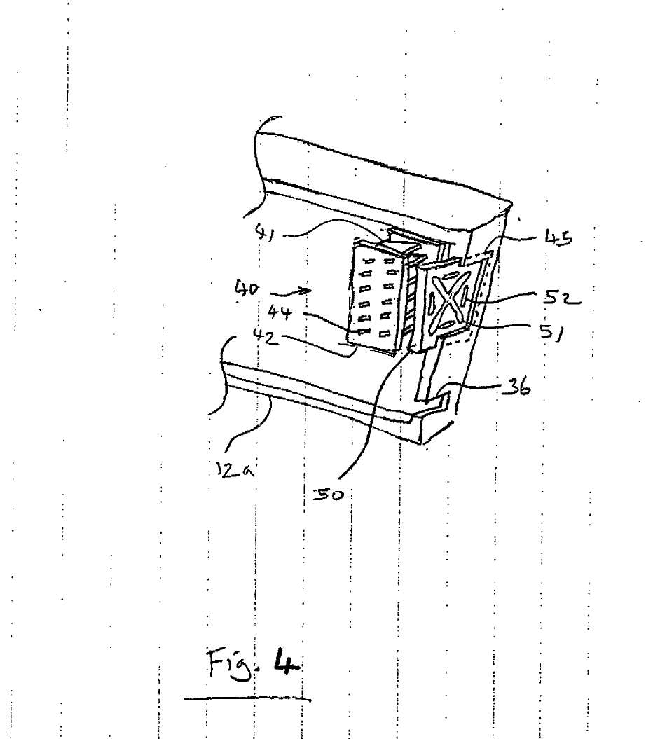

Arc chute, or arc extinguishing, assembly 40 is removably captivated within cassette 12 by molded detail 43 that is integral to cassette 12, and is best seen by referring to FIGS. 3 and 4. Arc plates 41, are typically, but not necessarily, arranged substantially parallel to one another, have tabs 44 that are captivated in corresponding slots in plate supports 42. Exhaust baffle 50 is removably captivated within cassette 12 by molded slot 45, shown in phantom in FIG. 3, that is integral to cassette 12. An X-slot 51 and rectangular slots 52 are formed in exhaust baffle 50, thereby providing through holes in exhaust baffle 50 for the passage of arc effluent generated from a short circuit interruption condition. The arc effluent passing through exhaust baffle 50 on line side 33 of circuit breaker 10 will exit case 17 through terminal chamber 37. The arc effluent passing through exhaust baffle 50 on load side 31 of circuit breaker 10 will exit case 17 through vent channel 38, shown in phantom in FIG. 2. Vent channels 38 are fully described in commonly assigned U.S. patent application Ser. No. 09/366,473 entitled “Bottom Vented Circuit Breaker Capable of Top Down Assembly Onto Equipment” filed Aug. 3, 1999, which is herein fully incorporated by reference.

Circuit Breaker Operating Handle Assembly

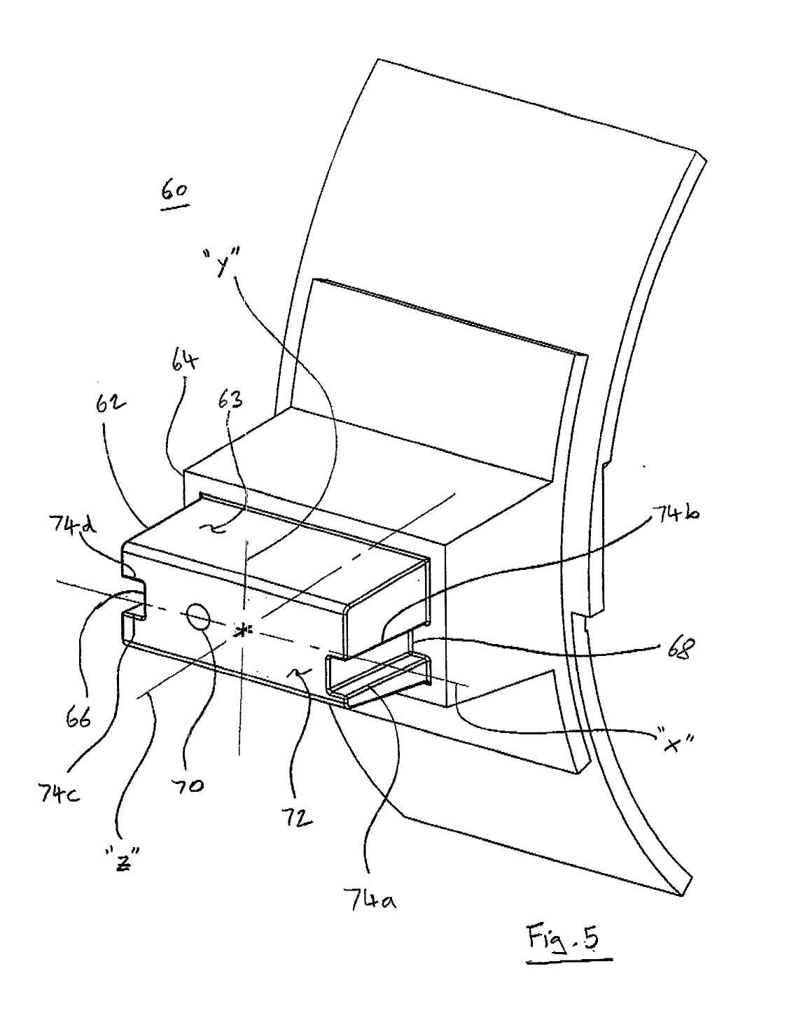

Referring now to FIGS. 5, 6 and 7, operating handle assembly 15, shown in FIG. 2, consists of handle base 60 and one of either handle extension 80 or handle extension 80′ coupled thereto. Handle base 60 includes handle stem 62, offset shelf 64, first recess 66, second recess 68, and coupling pilot hole 70. Handle extension 80 and 80′ includes operator interface surface 82, 82′, extension pocket 84, 84′, first projection 86, 86′, second projection 88, 88′, coupling through-hole 90, 90′, and engagement surface 92, 92′.

Handle extension 80 is assembled onto handle base 60 by aligning first and second projections, 86, 88, with first and second recesses 66, 68, respectively, and sliding extension pocket 84 over handle stem 62 until engagement surface 92 abuts offset shelf 64. A coupling screw, not shown, is inserted through coupling through-hole 90 and into coupling pilot hole 70. Coupling through-hole 90 is sized to permit passage of the threads of coupling screw, while coupling pilot hole 70 is sized to create an interference fit with the threads of coupling screw, thereby permitting the use of a coupling screw with self-tapping threads to securely engage handle extension 80 with handle base 60.

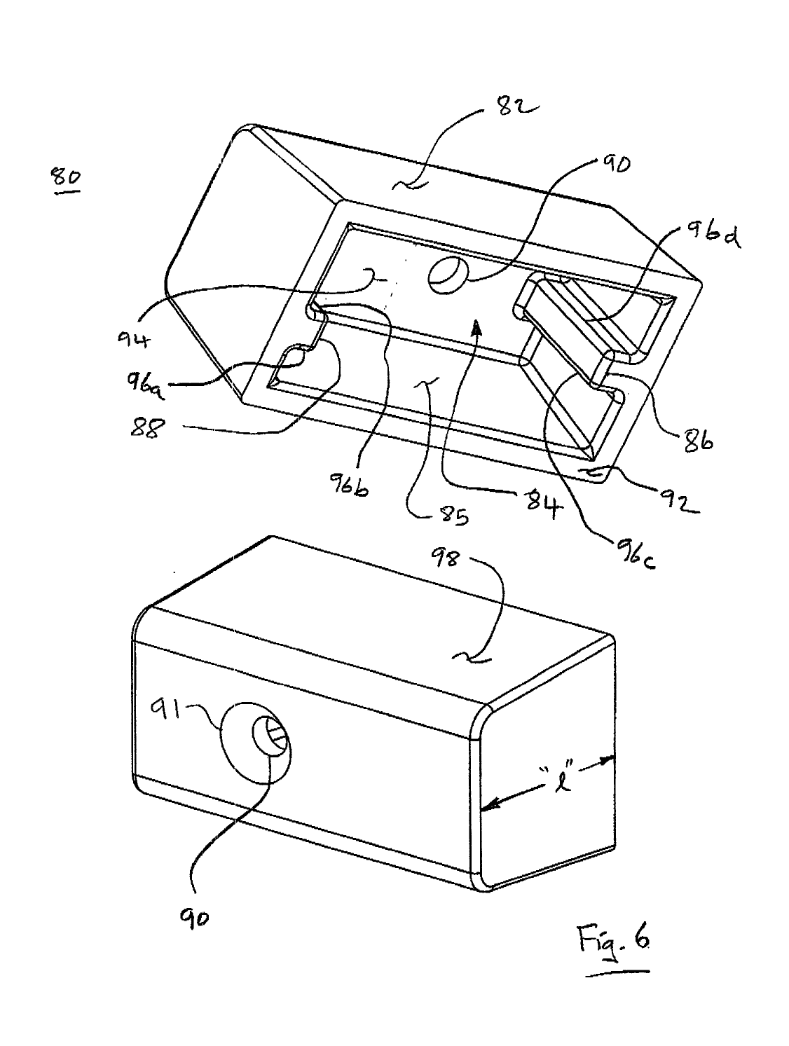

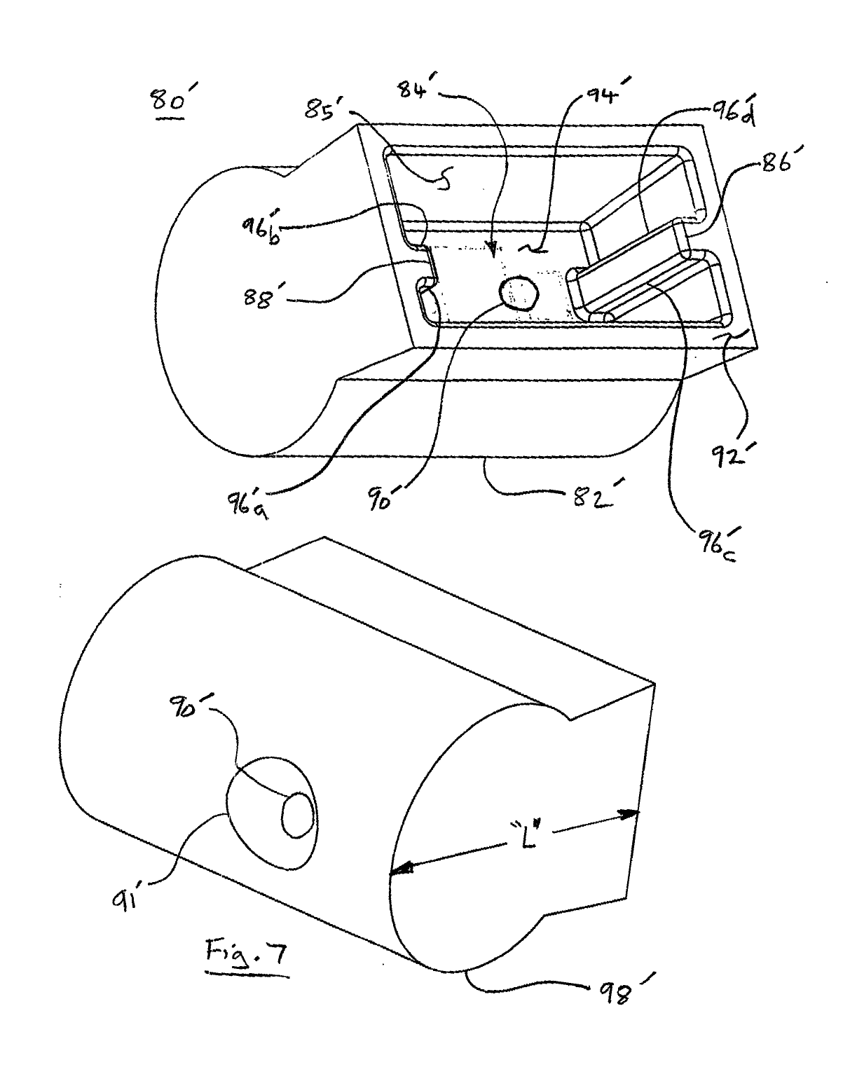

As can be seen by comparing like elements of handle extension 80 shown in FIG. 6 with handle extension 80′ shown in FIG. 7, a description of the assembly process of one will also apply to the other.

First and second recesses 66, 68, and first and second projections 86, 88, are offset from one another in the “Y” direction and by the same amount, thus requiring handle extension 80 to be oriented with first projection 86 aligned with first recess 66, and second projection 88 aligned with second recess 68 for proper assembly of handle extension 80 onto handle stem 62, thereby providing interference detail, or alternatively a rejection means, to prevent misalignment of handle extension 80 with handle stem 62. Additionally, coupling pilot hole 70 and coupling through-hole 90 are located off of the central “Z” axis of handle stem 62, thus providing additional asymmetry for proper assembly of handle extension 80 to handle stem 62, and providing appropriate electrical clearance from the coupling screw to the underside of handle base 60 where mechanism parts are in the proximity of the central “Z” axis. Some handle assembly designs may not require a rejection means by the offsetting of the engagement projections, recesses and coupling means, and therefore both symmetrical and asymmetrical handle extension arrangements are contemplated by the present invention.

The profiles of the cross-sectional areas of projections 86, 86′, 88, 88′, and recesses 66, 68, taken with respect to a “Z” plane (a “Z” plane is a plane perpendicular to the “Z” axis) (also, a “Z” plane is represented by surfaces 72, 94 and 94′), are shown in FIGS. 5, 6, and 7, to be rectangular. While the engagement of a rectangular projection, such as but not limited to a rib, with a rectangular recess, such as but not limited to a slot, will provide interacting surfaces 74a,b,c,d (side walls), and 96a,b,c,d (side edges), with action-reaction force vectors in the direction of the “Y” axis, such an arrangement is not intended to be limiting. Other profiles that could be employed for the cross-sectional areas of the projections and recesses include, for example, a circle, triangle or dove tail. While each of these alternative profiles would produce an “X”-direction force component between interacting surfaces 74, 96, 96′, which ordinarily would be undesirable because of the increased handle stress or cam-out action, they may be appropriate for low force-generating handle designs.

The completed handle assembly 15 results in handle extension 80 being securely coupled to handle base 60 by means of coupling screw, or other suitable fastener, not shown, and engagement surface 92 abutting offset shelf 64. In the assembled state, handle extension 80 cannot move relative to handle base 60. In essence, the two have become one and move in unison. The advantage of a two-part assembly as opposed to a one-piece part is seen by considering the manufacturing process, where the end product may be configured for a customer requesting a manually operated device or for a customer requesting a machine operated device. Removal and replacement of handle extension 80 from handle base 60 can be easily accomplished by removal and replacement of the coupling screw.

With a manually operated device, handle extension 80′ having contoured surface 98′ would be employed. Here, contoured surface 98′ is purposefully designed with human interaction in mind where length “L” of handle extension 80′ is designed to provide appropriate leverage for operating circuit breaker 10. Contoured surface 98′ provides for ease of operation of the switching device when operated by human hand, not shown, and a customer with large clearance around the handle assembly 15 could choose a handle extension 80′ with a large “L” dimension, while a customer with limited clearance around the handle assembly 15 would choose a handle extension 80′ with a small “L” dimension.

With a machine operated device, handle extension 80 having planar surface 98 would be employed. Here, planar surface 98 is purposefully designed with machine interaction in mind where length “I” of handle extension 80 is designed to work effectively with the output force of interacting machinery, not shown. Planar surface 98 provides for uniform surface stress distribution since it is void of stress-concentrating detail, such as projections or recesses, and length “I” could be chosen to work effectively with the output characteristics of a customer's operating equipment, not shown. Length “L” of handle extension 80′ is typically, but not necessarily, greater than length “I” of handle extension 80 since ease of operation of the switching device is generally more relevant when human interaction, as opposed to machine interaction, is involved.

Alternative Embodiment of Circuit Breaker Operating Handle Assembly

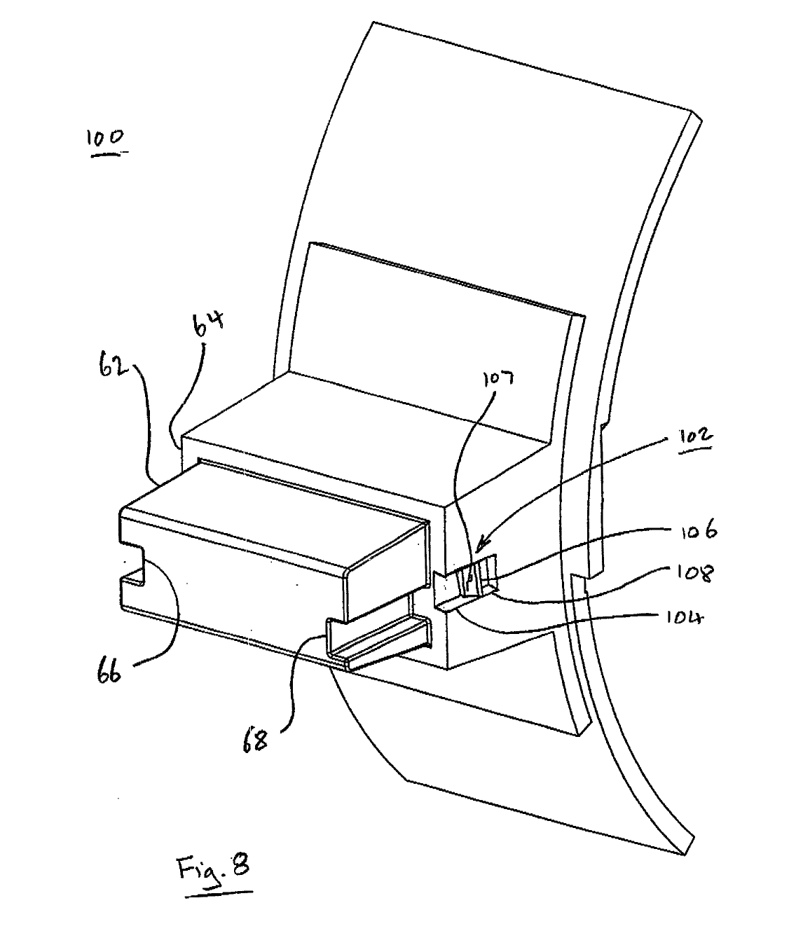

Handle extension 80 to handle base 60 coupling means has been described above as involving a coupling screw, not shown, inserted through coupling through-hole 90 and into coupling pilot hole 70. Coupling through-hole 90 is sized to permit passage of the threads of coupling screw, while coupling pilot hole 70 is sized to create an interference fit with the threads of coupling screw, thereby permitting the use of a coupling screw with self-tapping threads to securely engage handle extension 80 with handle base 60. While many types of coupling screws can be employed, such as round head, pan head, or flat head, countersink 91 indicates that the present invention employs a flat head coupling screw. An alternative coupling means to the coupling screw, which would eliminate the countersink 91 detail, is a snap fit coupling means, which is best seen by now referring to FIGS. 8, 9 and 10. For simplicity and clarity, elements shown in FIGS. 8, 9 and 10 that are identical to like elements in FIGS. 5, 6 and 7, are not enumerated but perform identical functions.

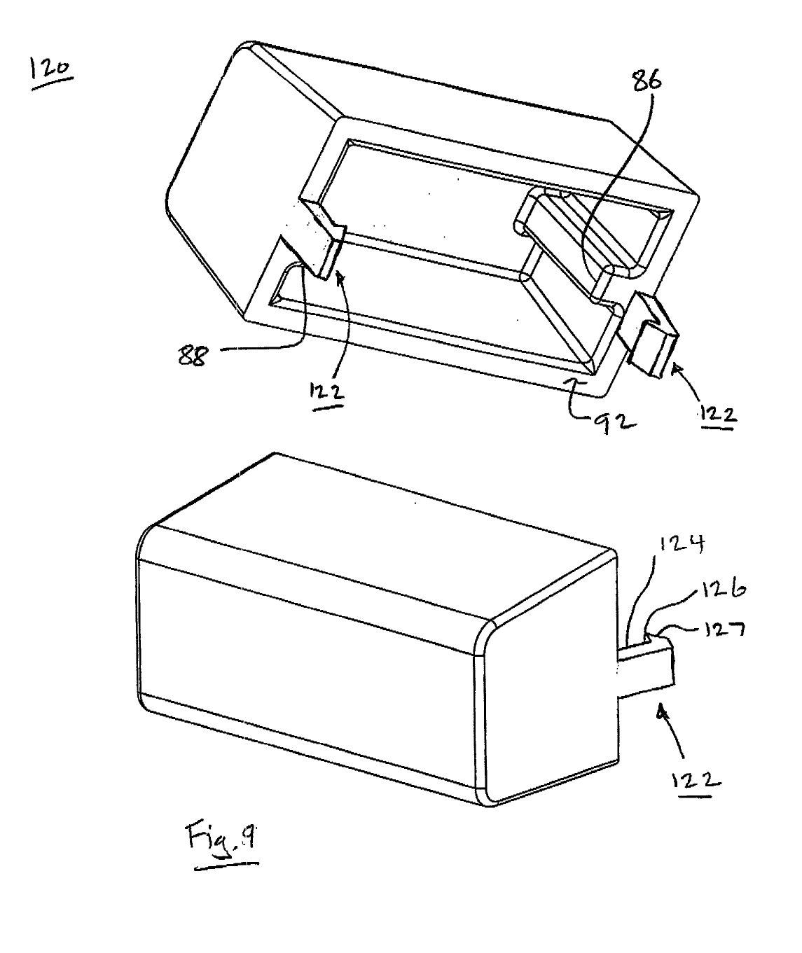

Engagement catch detail 102 on handle base 100, shown in FIG. 8, includes first relief 104, engagement catch surface 106, angled catch surface 107, and second relief 108. Flexible engagement latch 122 on handle extension 120, shown in FIG. 9, includes extension leg 124, engagement latch surface 126, and angled latch surface 127. Handle extension 120 is assembled onto handle base 100 by aligning flexible engagement latch 122 on handle extension 120 with engagement catch detail 102 on handle base 100, and by aligning first and second projections, 86, 88 on handle extension 120 with first and second recesses 66, 68 on handle base 100, respectively, and then sliding extension pocket 84 on handle extension 120 over handle stem 62 on handle base 100 until engagement surface 92 on handle extension 120 abuts offset shelf 64 on handle base 100. During the assembly process, angled latch surface 127 on flexible engagement latch 122 engages angled catch surface 107 on engagement catch detail 102 causing extension leg 124 to flex outward, thereby permitting engagement latch surface 126 to relax into second relief 108 and engage with engagement catch surface 106 prior to engagement surface 92 abutting offset shelf 64.

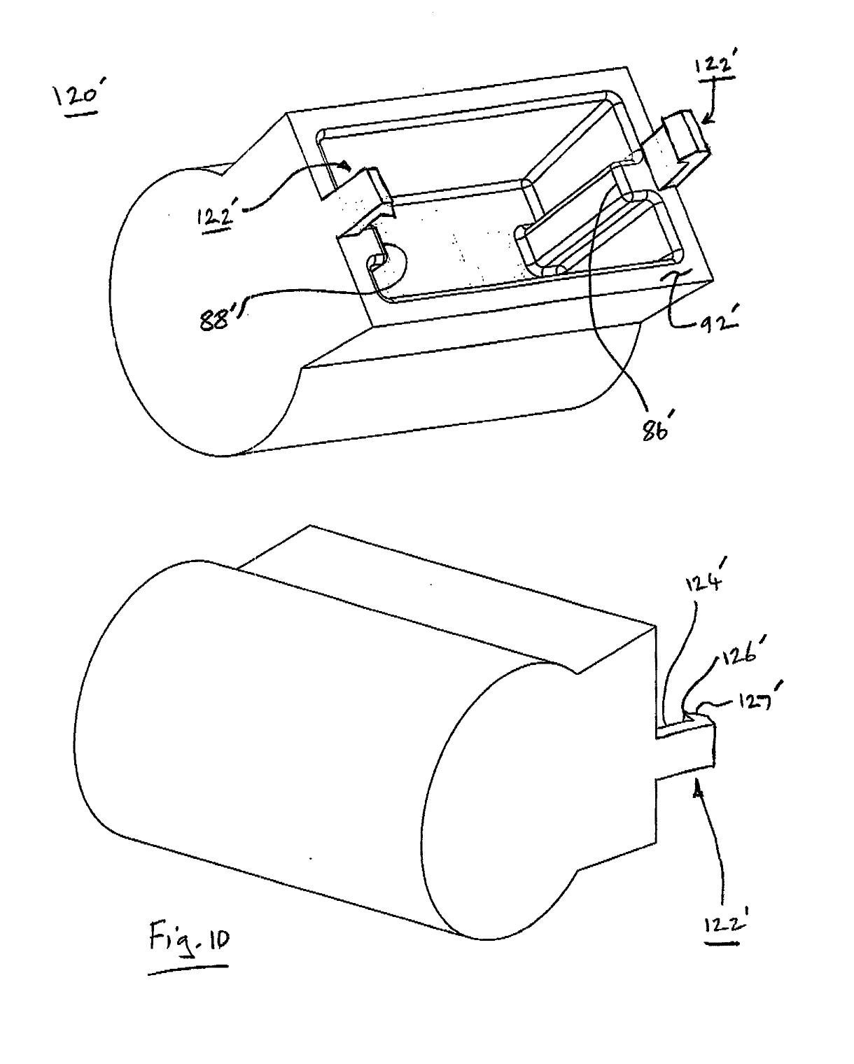

As can be seen by comparing like elements of handle extension 120 shown in FIG. 9 with handle extension 120′ shown in FIG. 10, a description of the assembly process of one will also apply to the other. Operation of Handle Assembly Generally Under quiescent operating conditions with the electrical switching device turned ON, operating mechanism 16 and electrical contacts 21a,b,c,d are in a closed condition. Since operating mechanism 16 is operatively connected to contact arm 20 by link 25, rotor 26, and connecting pins 27a,b, the electrical switching device can be turned OFF by actuating operating handle assembly 15 to position operating mechanism 16 and electrical contacts 21a,b,c,d in an open condition. The actuation of operating handle assembly 15 requires an external force, from either a human or machine source, to be applied to handle extension 80. Generally, but not necessarily, an external force originating from a machine source is applied to handle extension 80 or 120, while an external force originating from a human source is applied to handle extension 80′ or 120′. Hereinafter reference will be made to handle extension 80, but the discussion will equally apply to handle extension 80′, 120, and 120′, unless otherwise indicated.

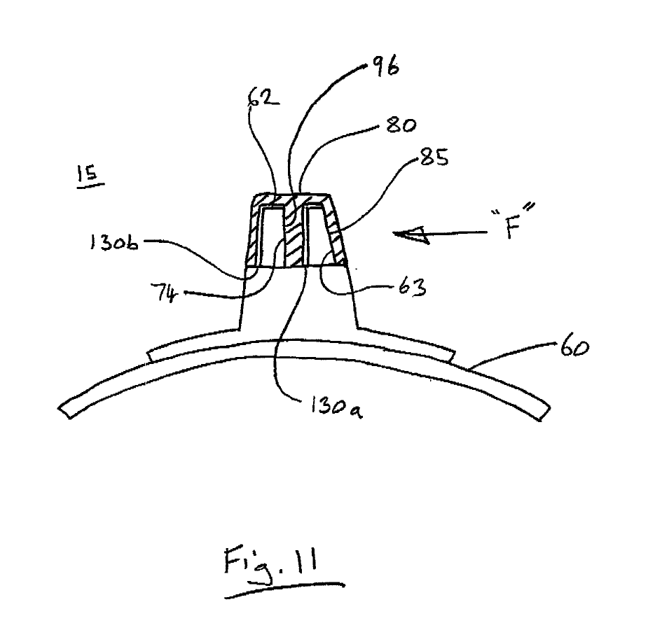

Reference is now made to FIG. 11, which has some detail missing for clarity. When an external force “F” from an external environment, that is, an environment outside of the circuit breaker, is applied to handle extension 80, handle extension 80 is biased in the direction of the applied force, resulting in contact between internal wall 85 of extension pocket 84 and associated external wall 63 of handle stem 62, and resulting in contact between side edges 96 of projections 86, 88 and associated side walls 74 of recesses 66, 68. The biasing of handle extension 80 against handle stem 62 is further represented by the presence of gaps 130a,b between handle extension 80 and handle stem 62. The interaction of these multiple surfaces effectively transmits the applied external force “F” from handle extension 80 to handle base 60, thereby providing the means to actuate operating mechanism 16, which is operatively connected to handle base 60, from ON to OFF and from OFF to ON.

While this invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

Element List

| | |
|---|---|
| 10 | circuit breaker |
| 11 | cover |
| 12 | cassette |
| 12a,b | cassette halves |
| 13 | opening |
| 14 | escutcheon |
| 15 | operating handle assembly |
| 16 | operating mechanism |
| 17 | case |
| 18a | trip unit |
| 18b | trip unit housing |
| 19 | current sensors |
| 20 | movable contact arm |
| 20′ | movable contact arm - phantom |
| 21a-d | electrical contacts |
| 22 | pocket |
| 23 | pocket |
| 25 | link |
| 26 | rotor |
| 27a,b | connecting pins |
| 30 | load terminal |
| 31 | load side |
| 32 | line terminal |
| 33 | line side |
| 34 | fixed contact arm |
| 35 | fixed contact arm |
| 36 | opening |
| 37 | terminal chamber |
| 38 | vent channel |
| 39 | sensor strap |
| 40 | arc chute |
| 43 | molded detail |
| 41 | arc plates |
| 42 | plate supports |
| 44 | tabs |
| 45 | molded slot |
| 50 | exhaust baffle |
| 51 | x-slot |
| 52 | rectangular slots |
| 60 | handle base |
| 62 | handle stem |
| 63 | external wall |
| 64 | offset shelf |
| 66 | first recess |
| 68 | second recess |
| 70 | coupling pilot hole |
| 72 | surface |
| 74a-d | interacting surfaces (side walls) |
| 80 | handle extension |
| 80′ | handle extension |
| 82 | operator interface surface |
| 82′ | operator interface surface |
| 84 | extension pocket |
| 84′ | extension pocket |
| 85 | internal wall |
| 86 | first projection |
| 86′ | first projection |
| 88 | second projection |
| 88′ | second projection |
| 90 | coupling through-hole |
| 90′ | coupling through-hole |
| 91 | countersink |
| 92 | engagement surface |
| 92′ | engagement surface |
| 94 | surface |
| 94′ | surface |
| 96a-d | interacting surfaces (side edges) |
| 96′a-d | interacting surfaces (side edges) |
| 98 | planar surface |
| 98′ | contoured surface |
| 100 | handle base |
| 102 | engagement catch detail |
| 104 | first relief |
| 106 | engagement catch surface |
| 107 | angled catch surface |
| 108 | second relief |
| 120 | handle extension |
| 120′ | handle extension |
| 122 | engagement latch detail |
| 124 | extension leg |
| 126 | engagement latch surface |
| 127 | angled latch surface |
| 130a,b | gaps |
| 200 | distribution panel |
| 202 | panel base |
| 204 | panel cover |
| 206 | interior assembly |
| 208 | panel housing |
| 210 | mounting holes |
| 212 | upstanding supports |
| 214 | attachment surfaces |
| 216 | holes |
| 218 | main support |
| 220 | at least one busbar |
| 222 | plurality of branch circuit connections |
| 224 | ground connector |
| 226 | neutral connector |

What is claimed is:

1. An operating handle assembly comprising:
a handle base having a handle stem for receiving at least one handle extension for interaction with an external environment;
one of said at least one handle extension coupled to said handle stem of said handle base for receiving an applied force from said external environment;
whereby said coupling restricts relative motion between said one of at least one handle extension and said handle base; and
further whereby said coupling provides for the removal and replacement of said one of at least one handle extension with respect to said handle base.

2. The operating handle assembly of claim 1 further comprising auxiliary interacting surfaces for transmitting an applied force from said handle extension to said handle base.

3. The operating handle assembly of claim 2 wherein said auxiliary interacting surfaces comprise at least one projection with an associated recess.

4. The operating handle assembly of claim 3 wherein said projection and said associated recess comprise a rib and slot, respectively.

5. The operating handle assembly of claim 4 wherein the cross-section profile of said rib and said slot is selected from the group consisting of rectangle, circle, triangle, and dove tail.

6. The operating handle assembly of claim 2 wherein said auxiliary interacting surfaces are asymmetrical about said handle stem to prevent improper assembly of said handle extension to said handle base.

7. The operating handle assembly of claim 6 wherein said auxiliary interacting surfaces comprise at least one rib and at least one associated slot.

8. The operating handle assembly of claim 1 wherein said coupling comprises a fastener.

9. The operating handle assembly of claim 1 wherein said coupling comprises an engagement latch and engagement catch.

10. The operating handle assembly of claim 8 wherein said fastener comprises a screw.

11. An electrical switching device comprising;
an operating mechanism for making and breaking an electrical current;
a terminal for mechanically and electrically connecting to a power source;
a terminal for mechanically and electrically connecting to a protected circuit;
a trip unit operatively coupled to said operating mechanism for effectuating the making and breaking of said electrical current;
an arc extinguishing assembly for extinguishing an electrical arc resulting from said breaking of said electrical current;
a case and cover for housing for said electrical switching device components;
an operating handle assembly for interfacing with said operating mechanism through said cover; wherein
said operating handle assembly comprises a handle base having a handle stem for receiving at least one handle extension for interaction with an external environment, one of said at least one handle extension coupled to said handle stem of said handle base for receiving an applied force from said external environment, whereby said coupling restricts relative motion between said one of at least one handle extension and said handle base, and further whereby said coupling provides for the removal and replacement of said one of at least one handle extension with respect to said handle base.

12. The electrical switching device of claim 11 wherein said operating handle assembly further comprising auxiliary interacting surfaces between said handle base and said one of at least one handle extension for transmitting an applied force from said handle extension to said handle base, said auxiliary interacting surfaces comprising a projection and an associated recess, wherein said projection and said associated recess must be aligned in order to assemble said handle extension to said handle base.

13. An electrical switching device comprising;
an operating mechanism for making and breaking an electrical current;
a terminal for mechanically and electrically connecting to a power source;
a terminal for mechanically and electrically connecting to a protected circuit;
a current sensor for monitoring the current in the protected circuit;
a trip unit for initiating a trip signal to break an electrical current upon the existence of an overcurrent condition in the protected circuit;
said trip unit operatively coupled to said operating mechanism for mechanically responding to said trip signal to effectuate the breaking of said electrical overcurrent;
an arc extinguishing assembly for extinguishing an electrical arc resulting from said breaking of said electrical overcurrent;
a case and cover for housing for said electrical switching device components;
an operating handle assembly for interfacing with said operating mechanism through said cover; wherein
said operating handle assembly comprises a handle base having a handle stem for receiving at least one handle extension for interaction with an external environment, one of said at least one handle extension coupled to said handle stem of said handle base for receiving an applied force from said external environment, whereby said coupling restricts relative motion between said one of at least one handle extension and said handle base, and further whereby said coupling provides for the removal and replacement of said one of at least one handle extension with respect to said handle base.

14. The electrical switching device of claim 13 wherein said operating handle assembly further comprising auxiliary interacting surfaces between said handle base and said one of at least one handle extension for transmitting an applied force from said handle extension to said handle base, said auxiliary interacting surfaces comprising a projection and an associated recess, wherein said projection and said associated recess must be aligned in order to assemble said handle extension to said handle base.

15. A molded case circuit breaker comprising;
at least one pair of electrical contacts for making and breaking an electrical current and for supporting an electrical arc therebetween, said at least one pair of electrical contacts having at least one movable contact;
a terminal for mechanically and electrically connecting to a power source;
a terminal for mechanically and electrically connecting to a protected circuit;
at least one contact arm disposed between said power source terminal and said protected circuit terminal for moving said at least one movable contact;
a trip unit operatively coupled to said protected circuit terminal for transmitting a signal to initiate a trip action to open said at least one pair of electrical contacts upon the existence of an overcurrent condition;
an operating mechanism operatively coupled to said trip unit and said at least one contact arm for responding to said signal from said trip unit to open said at least one pair of electrical contacts when an overcurrent condition exists;
an arc extinguishing assembly for extinguishing an electrical arc drawn between said at least one pair of electrical contacts as said at least one pair of electrical contacts open due to the trip action initiated by said trip unit;
a case for partially enclosing and supporting said circuit breaker components;
a cover coupled to said case for substantially completing the enclosure of said circuit breaker components;
an operating handle assembly operatively connected to said operating mechanism and extending through said cover for operating said at least one pair of electrical contacts between an open and closed position; wherein
said operating handle assembly comprises a handle base having a handle stem for receiving at least one handle extension for interaction with an external environment, one of said at least one handle extension coupled to said handle stem of said handle base for receiving an applied force from said external environment, whereby said coupling restricts relative motion between said one of at least one handle extension and said handle base, and further whereby said coupling provides for the removal and replacement of said one of at least one handle extension with respect to said handle base.

16. The molded case circuit breaker of claim 15 wherein said operating handle assembly further comprising auxiliary interacting surfaces between said handle base and said one of at least one handle extension for transmitting an applied force from said handle extension to said handle base, said auxiliary interacting surfaces comprising a projection and an associated recess wherein said projection and said associated recess must be aligned in order to assemble said handle extension to said handle base.

17. A method for assembling an operating handle assembly having a handle base and at least one handle extension comprising the steps of;
selecting said handle base having a first alignment surface and a first coupling surface;
selecting one of said at least one handle extension having a second alignment surface and a second coupling surface;
aligning said first and said second alignment surfaces;
assembling said one of at least one handle extension to said handle base wherein said first alignment surface and said second alignment surface are aligned;
coupling said one of at least one handle extension to said handle base by engaging said first coupling surface with said second coupling surface, wherein said first and said second coupling surfaces provide for the removal and replacement of said one of at least one handle extension with respect to said handle base.

18. An electrical distribution panel comprising;
a circuit breaker for connecting and disconnecting a protected circuit;
a main support for supporting said circuit breaker;
a plurality of branch circuit connections for connecting to a plurality of branch circuits;
at least one busbar for electrically connecting said circuit breaker to said plurality of branch circuit connections;
a ground connector for providing an electrical ground connection;
a neutral connector for providing an electrical neutral connection;
a panel base for supporting said main support and said plurality of branch circuit connections;
a panel cover coupled to said panel base; wherein
said circuit breaker comprises an operating handle assembly comprising a handle base having a handle stem for receiving at least one handle extension for interaction with an external environment, one of said at least one handle extension coupled to said handle stem of said handle base for receiving an applied force from said external environment, whereby said coupling restricts relative motion between said one of at least one handle extension and said handle base, and further whereby said coupling provides for the removal and replacement of said one of at least one handle extension with respect to said handle base.
